(19) United States
(12) Patent Application Publication
(10) Pub. No.: US 2007/0054697 A1
(43) Pub. Date: Mar. 8, 2007

(54) MOBILE NETWORK COMMUNICATION DEVICE AND KIT FOR A WIRELESS NETWORK

(76) Inventors: James Keith Money, Heathrow, FL (US); William Ross Walker, Sanford, FL (US)

Correspondence Address: WILDMAN HARROLD ALLEN & DIXON, 225 WEST WACKER DRIVE, SUITE 2800, CHICAGO, IL, 60606, US

(21) Appl. No.: 11/383,792

(22) Filed: May 17, 2006

Related U.S. Application Data
(60) Provisional application No. 60/715,974, filed on Sep. 7, 2005.

(51) Int. Cl. H04B 1/38; H04M 1/00

(52) U.S. Cl. 455/557

(57) ABSTRACT

A system and kit for establishing voice, video and data communication between network communication devices of a wireless local area network are provided. The network communication devices each have a wireless access control unit operable at a computer-based device. The wireless access control unit is adapted to provide wireless network connectivity for the network communication device. An antenna is coupled with the wireless access control unit of the network communication device. A communication application is operable at the computer-based device to provide the network communication device with voice, video and data communication capabilities between the network communication devices forming the wireless local area network.

### CROSS REFERENCE TO RELATED APPLICATIONS

This application claims priority from U.S. Provisional Patent Application No. 60/715,974 filed on Sep. 7, 2005.

### FIELD OF INVENTION

The present invention relates to network communication devices and more particularly to network communication devices communicating in wireless broadband local area networks.

### BACKGROUND OF THE INVENTION

Recent developments to wireless networking standards and technologies have enabled the use of wireless routers and repeaters in home and office settings to provide networking capabilities. Often certain infrastructure is needed to provide the necessary power and connectivity for such networks. However, for mobile network users, such as first responders, law enforcement officers, and other emergency personnel, who may be traveling in moving vehicles at highway speeds, such wireless networking approaches may not provide acceptable or reliable broadband network connectivity. Additionally, a traditional server-based infrastructure may be needed for authentication of devices communicating in a network. Moreover, in many known systems, data transfer rates degrade significantly when network users are traveling at high speeds, such as highway speeds.

It is desirable to have a wireless local area network having secure and reliable data transfers that may be deployed in a variety of terrains and environmental conditions. It is further desirable to provide a portable, independent, readily deployable system for wireless networking that securely and seamlessly transmits data to and from network users, even if the users are traveling in vehicles moving at highway speeds.

### BRIEF DESCRIPTION OF THE DRAWINGS

Certain embodiments of the present invention are illustrated by the accompanying figures. It should be understood that the figures are not necessarily to scale and that details not necessary for an understanding of the invention or that render other details difficult to perceive may be omitted. It should be understood, of course, that the invention is not necessarily limited to the particular embodiments illustrated herein.

FIG. 1 is a system diagram depicting network communication devices communicating in a wireless local area network.

FIG. 2 illustrates an example network communication device for communication in the wireless local area network.

FIG. 3 illustrates an example of a kit for a network communication device that communicates within the wireless local area network.

### DETAILED DESCRIPTION

A kit for establishing voice, video and data communication between network communication devices of a wireless local area network is provided. The kit contains a wireless access control unit that is insertable into a computer-based device (such as a laptop computer or a personal computer) to provide wireless network connectivity to the computer-based device. An antenna for receipt and transmission of signals through the wireless local area network is coupled for communication with the wireless access control unit. A communication application stored on a memory device, such as a compact disk, is provided in the kit to be downloaded and run on the computer-based device. The communication application provides voice, video and data communication between the network communication devices forming the wireless local area network. The kit may come with a portable carrying case containing the wireless access control unit, the communication application stored on the memory device, the antenna, a Universal Serial Bus (USB) video camera, a headset, and a DC power adapter. The kit may be used to configure the computer-based device to an operational network communication device for voice, video and data communication with other network communication devices over the wireless local area network.

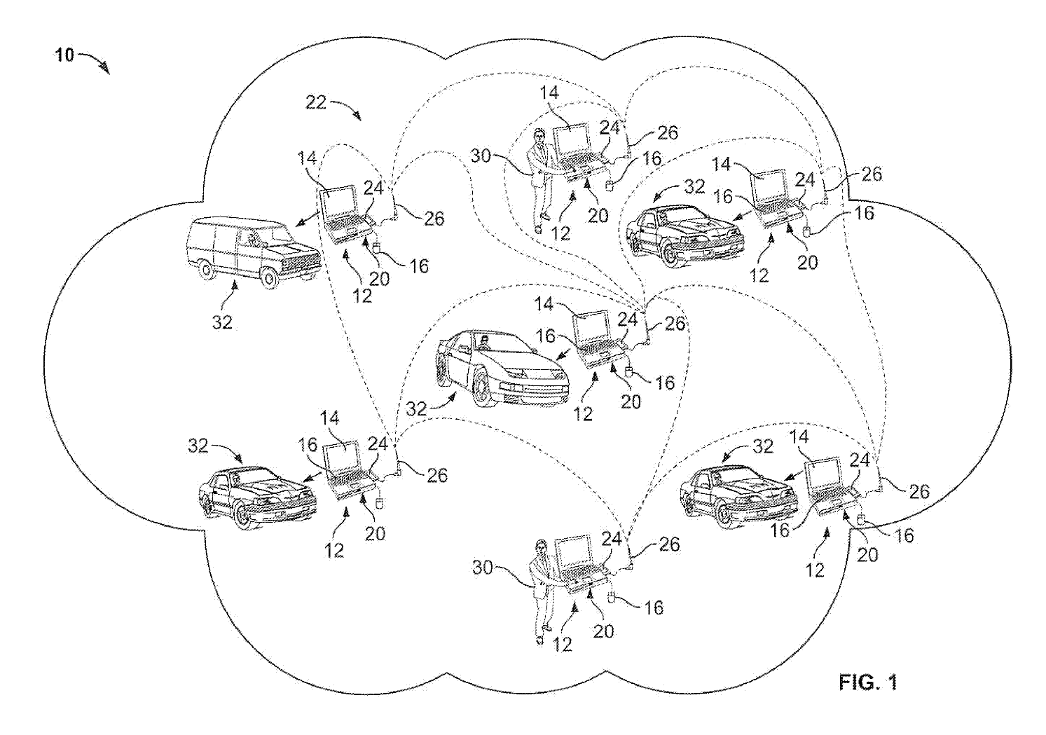

Referring to FIG. 1, a wireless local area network 10 is illustrated with network communication devices 12 signaling with one another in forming the network. The network communication devices 12, in this example, include a display screen 14 for the presentation of information to users and one or more user input devices 16 (such as a keyboard, keypad, mouse, stylus, touchscreen, or any other computer input device) for inputting information and performing actions at the network communication devices. The network communication devices 12 of the wireless local area network 10 are operable on a corresponding computer-based device 20. The computer-based device 20 used as part of the network communication device 12 may selectively be a laptop computer, personal computer (PC), wireless telephone, personal digital assistant (PDA), or any other device adaptable to receive and/or transmit voice, video or data. Each network communication device 12 comprises an operating system capable of network connectivity. Each network communication device 12 is capable of routing data packets to other communication devices of the network.

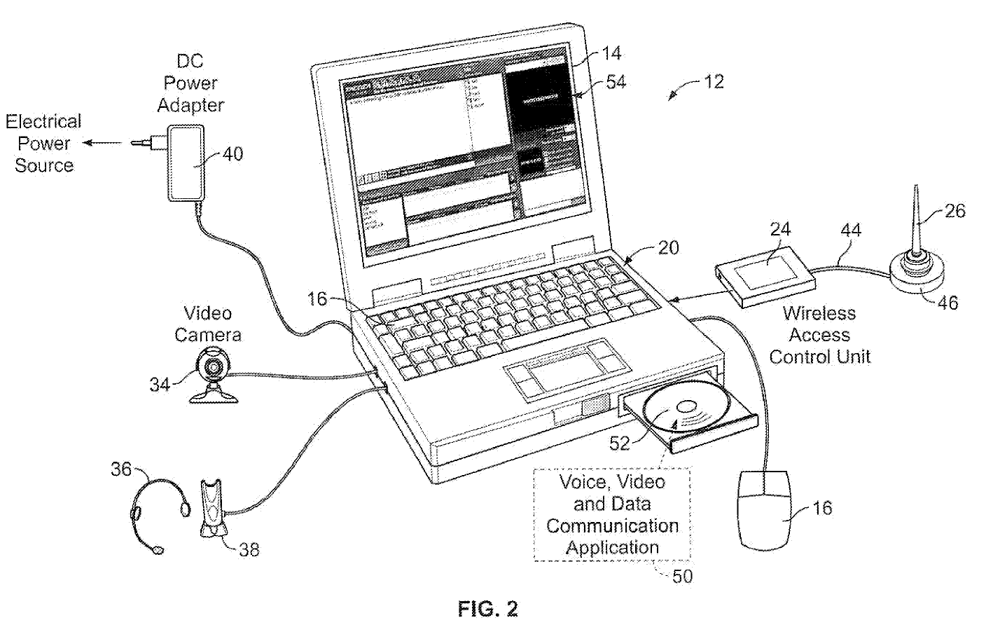

As seen in FIG. 1, a system 22 for establishing communication in the wireless local area network 10 is provided. Each of the computer-based devices 20 is coupled for communication with a corresponding wireless access control unit 24 adapted to provide network connectivity for the network communication devices 12. The wireless access control units 24 are each connected with a corresponding antenna 26 to transmit and receive signals in the network 10. A voice, video and data communication application 50, FIG. 2, is run on the network communication devices 12. As discussed herein, the communication application 50 operates on the computer-based devices 20, FIG. 1, to provide each of the network communication devices 12 with voice, video and data communication capabilities within the wireless local area network 10.

Network connectivity and voice, video and data communication are maintained as the network communication devices are moved from location to location in the wireless local area network 10, FIG. 1. A user 32 may transport a network communication device 12 throughout the network 10 while maintaining network connectivity and the ability to broadcast voice, video and data information to one or more other communication devices in the network. This may be particularly useful for many different users (such as tactical teams, first responders, law enforcement personnel, emergency personnel and the like) as the users are able to randomly deploy and set up a secure wireless local area network at various remote areas in the field. Additionally, the network communication devices 12 may be placed in a vehicle 32 and communicate with other network devices while in transit in the moving vehicle. The wireless access control units 24 operating at the network communication devices 12 maintain network connectivity even as individual network communication devices are transported in a moving vehicle at speeds in excess of 100 miles per hour, for example, even at high speeds up to 200-250 miles per hour. Voice, video and data communication capabilities established through operation of the communication application 50, FIG. 2, are also maintained as the network communication device 12 is transported at such high speeds.

The network communication devices 12, FIG. 1, are self-authenticating. The software-based network communication devices 12 automatically search for available users (at other pre-configured network communication devices) to provide secure authentication and access for broadband network connectivity. The network communication devices 12 send and receive voice, video and data to other network communication devices in the absence of a centralized server responsible for authenticating and coordinating network communication devices entering the wireless local area network 10. The network configuration devices 12 provide direct peer-to-peer communication between devices in the network without the need for access points or a traditional wired network infrastructure.

The network communication devices communicate with each other to form, for example, a self-authenticating, self-healing, self-forming, peer-to-peer, wireless local area network. The software-based communication application runs on each network communication device to provide the establishment and maintenance of and voice, video and data communication with various types of networks, including mobile networks, ad-hoc networks, and wireless mesh networks, without reliance on a centralized server used for authenticating network communication devices entering the network. A mobile or ad-hoc network is a self-configuring network of communication devices connected by wireless links, each network communication device being free to move randomly and organize arbitrarily. Thus, the topology for the network may dynamically change depending on the location of the various network communication devices. The mobile or ad-hoc network may, for example, be a local area network.

A mesh network is a network that routes data between nodes in the absence of a centralized server used for authentication. Mesh networks provide continuous connections and reconfiguration around blocked paths by hopping from node to node in the most efficient path possible until connections can be established. Mesh networks are self healing, which means that the network can still operate even when a node or other connection is inoperable. Each node within the network authenticates the others. The nodes may, for example, be network communication devices or alternatively, routers or network access points. Nodes are spaced at distances from each other in the local area of coverage for the wireless network. Increasing the number of nodes increases the distance the wireless local area network can span.

These networks can be established and maintained through network participation packets sent between the various network communication devices within the network. The wireless local area networks are established through signaling between two or more network communication devices. Each network communication device transmits and receives signals from the other devices in the network. The voice, video and data communication application runs on the network communication devices of the network and automatically builds and maintains a list of available users associated with the network communication devices in real-time. At start-up, the communication application searches for other network communication devices, and during operation monitors and updates the lists of available users on the network.

As provided herein, the interaction between the network communication devices forms the mobile wireless network, and thus, a conventional network infrastructure of servers, routers, repeaters and the like are not required to create the network. The communication application, 50, FIG. 2, enables users at the network communication devices to connect to one other in the absence of a centralized server to form a wireless network. Text, voice and video communication is provided between the network communication devices within the wireless network independent of a centralized software platform. The wireless local area network formed through the interaction between the network communication devices is mutable such that it is able to run on many different communication platforms. Network broadband connectivity over various protocols, such as UDP, Internet Protocol (IP), Transmission Control Protocol (TCP), Sequenced Packet Exchange (SPX), Internet Packet Exchange (IPX), and other communication protocols, is provided at vehicular speeds in excess of 100 mph. The communication application process is also adapted to run in traditional centralized or structured server environments. For further details on the voice, video and data communication application and the establishment, connectivity, and communication of the wireless local area networks, reference can be made to U.S. patent application Ser. No. 11/383,775 of Dumas et al. entitled “Application and Method for Dynamically Updating and Communicating Within Flexible Networks” filed on May 17, 2006 and assigned to the same assignee of the present invention which is hereby incorporated by reference in its entirety.

Referring to FIG. 2, an example of a network communication device 12 is shown. In this example, the computer-based device 20 of the network communication device 12 may be a laptop computer. For mobile communications, the computer-based device 20 may selectively be mounted inside of a vehicle in a location convenient to the user and an electrical power source terminal, such as the vehicle cigarette lighter outlet. Video camera 34 is coupled with the computer-based device 20 to provide video data to the network communication device 12. The video camera 34 may selectively be a USB video camera connected with a USB port of the computer-based device 20. A headset 36 is coupled with the computer-based device 20 for transmitting audio signals to and receiving audio signals from the computer-based device. The headset 36 may, for example, be a wireless headset having an associated headset charger 38 that is connected with the computer-based device 20 through a USB port.

The network communication device 12, in the example seen in FIG. 2, has DC power adapter 40 that couples an external electrical power source with the computer-based device 20. In this example, one end of the DC power adapter is connected to the computer-based device 20 with the other end being connected to an electrical power source, such as an electrical power source for a vehicle. Additional DC power adapters may selectively be utilized for further access to the electrical power source of a vehicle.

Network connectivity is provided through the wireless access control unit 24. The wireless access control unit 24 may, for example, be a wireless modem card that is insertable into a PCMCIA (Personal Computer Memory Card International Association) card slot of the computer-based device 20. The wireless modem card 24 and the operating system of the computer-based device are pre-configured in order to identify the computer-based device 20 as being an authenticated network device such that communication with other network communication devices 12 in the wireless network is permitted. For example, a WMC6300 model wireless modem card sold by Motorola, Inc. may be employed as a wireless access control unit. Cable 44 is connected to the wireless access control unit 24 and couples the antenna 26 to the wireless access control unit. When the network communication device 12 is mounted in a vehicle, cable 44 may, for example, be an RF coaxial cable that is threaded through the vehicle to the trunk (or any unobtrusive location) where it connects to the wireless access control unit. In the example seen in FIG. 2, the antenna is connected with magnet mount 46. The magnet mount 46 is attachable to an exterior of a vehicle.

As described herein, a voice, video and data communication application 50 that is adapted to run on the computer-based device 20 of the network communication device 12 is provided. In this example, the software-based communication application 50 is stored on a memory device 52 to be downloaded and installed on the computer-based device 20. For instance, the memory device 52 may be a compact disk read only memory (CD ROM), or any other computer memory device. In this example, memory device 52 is insertable into a disk drive of the computer-based device 20. The communication application 50 provides the network communication device 12 direct voice, video and data communication capabilities with the other pre-configured network communication devices forming the wireless local area network. Once the communication application 50 is launched at the network communication device 12, a graphical user interface 54 appears in the display screen 14 to assist the user with the sending and receiving of voice, video and data with the other network communication devices in the network 10. The user launches the communication application 50 installed at the computer-based device 20, points the USB camera 34 in the area of interest, and does the headset 36. The network communication device 12 automatically searches for available network communication devices (pre-configured for communication within the network) for secure authentication and access to wireless broadband network connectivity. Voice, video, file transfers, chat and instant messaging capabilities are provided to the user at the network communication device 12, even when traveling at various speeds including speeds in excess of over 100 miles per hour.

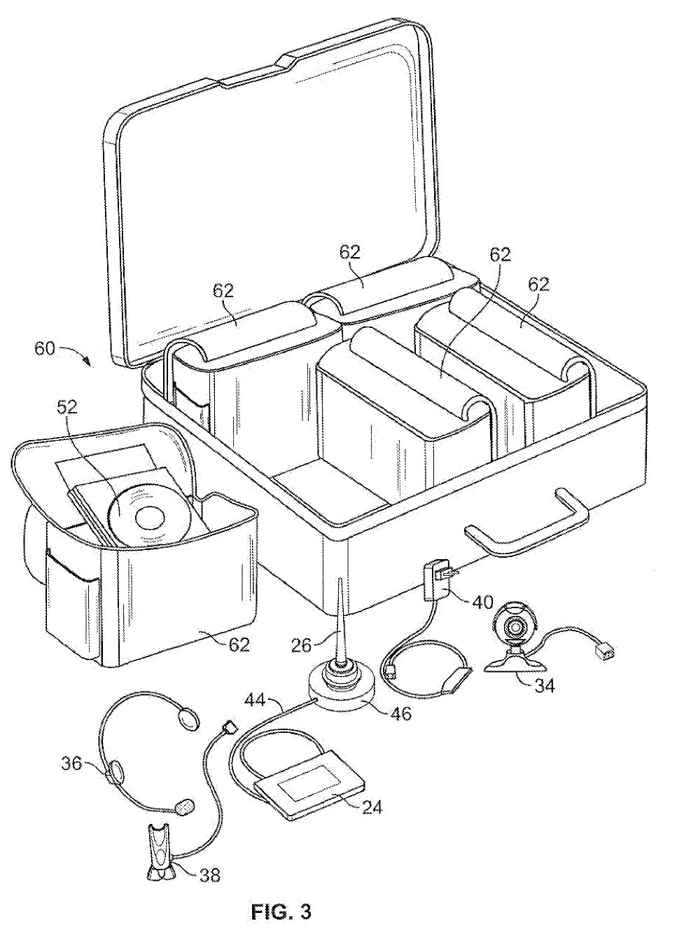

Referring now to FIG. 3, an example kit 60 for configuring a computer-based device 20 to a network communication device 12 for establishing communication in wireless local area network 10 is shown. The kit 60, in this example, has a portable carrying case 62 that contains: memory device 52 storing the software-based voice, video and data communication application 50; wireless access control unit 24; RF coaxial cable 44; magnet mount 46; antenna 26; USB video camera 34; DC power adapter 40; wireless headset 36; and headset changer 38. A number of portable carrying cases 62 containing these items may be deployed to a group of users (such as a tactical team) in order to establish a wireless local area network regardless of location. The kits 62 are used to configure corresponding computer-based devices 20 to network communication devices 12. The network communication devices 12 are capable of voice, video and data communication with each other over the established wireless local area network 10 in response to activation of the communication application of the network communication devices.

The foregoing description of the preferred embodiments of the invention have been presented for purposes of illustration and description, and are not intended to be exhaustive or to limit the invention the precise forms disclosed. The descriptions were selected to best explain the principles of the invention and their practical application to enable others skilled in the art to best utilize the invention in various embodiments and various modifications as are suited to the particular use contemplated. It is intended that the scope of the invention not be limited by the specification, but be defined by the claims set forth below.

What is claimed is:

1. A kit for establishing communication in a wireless local area network comprising:
a wireless access control unit adapted to provide wireless network connectivity to a computer-based device;
a communication application stored on a memory device, said communication application adapted to run on the computer-based device to provide voice, video and data communication within the wireless local area network in the absence of a server responsible for authenticating devices entering the network; and
an antenna adapted to be coupled with the wireless access control unit.

2. The kit of claim 1, further comprising a video camera adapted to be coupled with the computer-based device and provide video data to the computer-based device.

3. The kit of claim 2, further comprising a headset adapted to transmit audio signals to and receive audio signals from the computer-based device.

4. The kit of claim 3, wherein the headset is a wireless headset and further comprising a headset charger adapted to be coupled with the computer-based device.

5. The kit of claim 3, further comprising a DC power adapter adapted to couple the computer-based device with an external power source.

6. The kit of claim 5, further comprising a portable carrying case that contains: (a) the wireless access control unit, (b) the memory device storing the communication application, (c) the antenna, (d) the video camera, (e) the headset, and (f) the DC power adapter.

7. The kit of claim 6, further comprising a plurality of portable carrying cases, each portable carrying case carrying items (a)-(e) to configure a plurality of corresponding computer-based devices for voice, video and data communication with each other over a mobile ad-hoc network or a mesh network.

8. The kit of claim 6, further comprising a magnet mount for connection with the antenna, said magnet mount adapted to attach to an exterior of a vehicle; and
a cable adapted to couple the antenna and wireless access control unit.

9. The kit of claim 1, wherein the wireless access control unit further comprises a wireless modem card, said wireless modem card and memory device being insertable into the computer-based device such that network connectivity and voice, video and data communication are maintainable within the wireless local area network as the computer-based device is carried in a vehicle traveling at speeds over 100 miles per hour.

10. The kit of claim 9, wherein the wireless modem card is preconfigured to identify the computer-based device as a network device for communication within the wireless local area network.

11. A system for establishing communication in a wireless local area network comprising:
at least one network communication device, the at least one network communication device comprising a computer-based device coupled with a wireless access control unit adapted to provide wireless network connectivity for the network communication device;
a communication application operable at the computer-based device to provide the network communication device with voice, video and data communication capabilities within the wireless local area network in the absence of a server responsible for authenticating network communication devices entering the network; and
an antenna coupled with the wireless access control unit.

12. The system of claim 11, wherein network connectivity is maintained as the network communication device is transported at speeds in excess of 100 miles per hour.

13. The system of claim 12, wherein voice, video, and data communication capabilities are maintained at the network communication device as the network communication device is transported at speeds in excess of 100 miles per hour.

14. The system of claim 13, wherein the wireless access control unit is pre-configured to identify the network communication device as being a network device for communication within the wireless local area network.

15. The system of claim 13, wherein the wireless access control unit further comprises a wireless modem card insertable into the computer-based device.

16. The system of claim 13, wherein the wireless local area network is at least one of: (a) a mobile ad-hoc network, and (b) a mesh network.

17. The system of claim 13, further comprising a plurality of network communication devices adapted to communicate voice, video and data with each other over the wireless local area network.

18. The system of claim 13, wherein the computer-based device of the network communication device is at least one of: (a) a laptop computer, and (b) a personal computer.

19. The system of claim 18, wherein the network communication device further comprises a video camera coupled with the computer-based device.

20. The system of claim 19, wherein the network communication device further comprises a headset adapted to transmit audio signals to and receive audio signals from the computer-based device.

21. The system of claim 20, wherein the headset is a wireless headset and further comprising a headset charger coupled to the computer-based device.

22. The system of claim 21, wherein the network communication device further comprises a DC power adapter to couple the computer-based device with an external power source.
